(19) United States
(12) Patent Application Publication
(10) Pub. No.: US 2016/0138172 A1
(43) Pub. Date: May 19, 2016

(54) Gasket With Internal Galvanic Anode Ring

(71) Applicant: Saudi Arabian Oil Company, Dhahran (SA)

(72) Inventor: Iyad A. Al-Buraiki, Dhahran (SA)

(73) Assignee: SAUDI ARABIAN OIL COMPANY, Dhahran (SA)

(21) Appl. No.: 14/543,010

(22) Filed: Nov. 17, 2014

(51) Int. Cl. C23F 13/10; F16L 23/18

(52) U.S. Cl. CPC C23F 13/10; F16L 23/18

(57) ABSTRACT

A gasket assembly for sealing between mating flange faces of a flanged connection with a central bore includes a seal member. The seal member is ring shaped and has a seal member profile on an inner diameter. A galvanic anode is a ring shaped member with an outer diameter that is in engagement with the seal member profile, and an inner diameter that is at least as large as a diameter of the central bore.

### BACKGROUND OF THE INVENTION

1. Field of the Invention

The present invention relates generally to gaskets for sealing flanged connections, and more specifically to systems and methods for providing corrosion protection to flange faces of the flanged connection with the gasket.

2. Description of the Related Art

Conduits such as pipes and hoses, as well as various equipment with conduit attachments, are sometimes connected to each other with flanged connections. The flanged connections have a central bore and flange faces normal to the axes of the conduits that mate and are clamped together. A gasket can be compressed between the mated flange faces to seal between the mated flange faces. The flanges can be clamped together with bolts or other threaded members, with an annular clamping ring, or by other known means.

The gasket can be radially offset a certain distance from the central bore. Fluids passing through the conduit can therefore pass into the flange inner faces between mated flange faces from the central bore to the gasket. Corrosion on the flange inner faces can occur, particularly when the fluid is considered highly corrosive. This type of corrosion sometimes results in leaks and affects the integrity of the systems associated with the flanged connections, often causing unscheduled shutdowns. Replacement or repair of the damaged flanged connections is often required. Flange face corrosion is more common in certain industries, such as hydrocarbon development and processing industries, and can result in significant maintenance, repair and replacement costs. Standard gaskets, such as ASME B16.20 ring joint gasket in all its variants, do not protect the flange faces from corrosion.

Flange inner faces can be coated to protect against corrosion, however, depending on the use of the flanged connection, such coatings may violate industry standards. The flange inner faces could also be isolated by providing an additional sealing member at the intersection of the central bore and the flange inner faces, providing a physical barrier to prevent corrosive fluids from reaching the flange inner faces. However, such additional sealing members are prone to failure and once they have failed, the additional sealing members do not provide corrosion protection to the flange inner faces.

### SUMMARY OF THE DISCLOSURE

Embodiments described herein disclose systems and methods for providing active corrosion protection for flange inner faces with a sacrificial galvanic anode. The gasket assembly of embodiments of this disclosure will fulfill its traditional purpose of sealing and preventing leaks between mating flange faces with a seal member, and will also mitigate flange face corrosion with a galvanic anode component. The galvanic anode does not need to seal between the mating flange faces in order to provide corrosion protection. Embodiments of this disclosure will be interchangeable with standard industry gaskets, such as, for example, ASME B16.20, without any modifications to the flanged connection.

In an embodiment of this disclosure, a gasket assembly for sealing between mating flange faces of a flanged connection with a central bore includes a seal member. The seal member is ring shaped and has a seal member profile on an inner diameter. A galvanic anode is a ring shaped member with an outer diameter that is in engagement with the seal member profile, and an inner diameter that is at least as large as a diameter of the central bore.

In alternate embodiments, the galvanic anode can be formed of aluminum, magnesium or zinc. The galvanic anode can have an axial height that is less than a distance between the mating flange faces. The seal member can be sized to engage a ring joint groove of the mating flange faces and the galvanic anode can be sized to extend from the ring joint groove to the central bore. Alternately, the gasket assembly can further including an outer ring, the outer ring having an inner diameter that engages an outer diameter of the seal member.

In other alternate embodiments, the seal member profile extends radially outward from the inner diameter of the seal member. Alternately, the seal member profile extends radially into the inner diameter of the seal member. In either embodiment, the outer diameter of the galvanic anode has an anode profile that engages the seal member profile.

In other embodiments of this disclosure, a sealed flanged connection includes mating flange faces with a central bore, the mating flange faces being annular members spaced axially apart. A seal member is located between the mating flange faces and forms a seal between the mating flange faces. The seal member is ring shaped and has a seal member profile on an inner diameter. A galvanic anode is a ring shaped member with an outer diameter in engagement with the seal member profile, and extending from the seal member towards the central bore. Opposite facing faces of the galvanic anode are spaced apart from the mating flange faces.

In alternate embodiments, the sealed flanged connection can also have a joint groove located on each of the mating flange faces. The seal member can be located within the joint groove and the galvanic anode extends from the joint groove to the central bore. The sealed flanged connection can alternately include an outer ring, the outer ring having an inner diameter that engages an outer diameter of the seal member. The outer ring can extend radially outward from the seal member between the mating flange faces.

In other alternate embodiments, the outer diameter of the galvanic anode loosely engages the seal member profile. Alternately, the outer diameter of the galvanic anode can be fixed to the seal member. The galvanic anode can be formed of aluminum, magnesium or zinc. The seal member can be a metallic gasket, camprofile gasket, kammprofile gasket, grooved gasket, or a spiral wound gasket.

In another alternate embodiment of this disclosure, a method of sealing between a pair of flanges of a flanged connection with a central bore, includes inserting a gasket assembly between mating flange faces of the flanged connection. The gasket assembly has a seal member with ring shape and an inner diameter, and a galvanic anode with a ring shape and an outer diameter in engagement with the seal member profile. The flanges are secured to each other to compress the seal member between the mating flange faces, while maintaining a space between each of opposite facing faces of the galvanic anode and the mating flange faces.

In alternate embodiments, the galvanic anode is sized to extend from the seal member to the central bore to protect an annular portion of the mating flange faces between the seal member and the central bore from corrosion with the galvanic anode. The mating flange faces can each have a joint groove and the seal member can be inserted within the joint groove. Alternately, the gasket assembly can have an outer ring with an inner diameter that engages an outer diameter of the seal member, and the gasket assembly can be radially centered between the mating flange faces with the outer ring.

### BRIEF DESCRIPTION OF THE DRAWINGS

So that the manner in which the above-recited features, aspects and advantages of the invention, as well as others that will become apparent, are attained and can be understood in detail, a more particular description of the invention briefly summarized above may be had by reference to the embodiments thereof that are illustrated in the drawings that form a part of this specification. It is to be noted, however, that the appended drawings illustrate only preferred embodiments of the invention and are, therefore, not to be considered limiting of the invention's scope, for the invention may admit to other equally effective embodiments.

FIG. 1 is a section view of a flanged connection with a gasket assembly in accordance with an embodiment of this disclosure.

FIG. 2 is a section view of a flanged connection with a gasket assembly in accordance with an alternate embodiment of this disclosure.

FIG. 3 is detail section view of portion of a flanged connection with gasket assembly in accordance with an embodiment of this disclosure.

FIG. 4 is detail section view of portion of a flanged connection with gasket assembly in accordance with an alternate embodiment of this disclosure.

FIG. 5 is a cross section view of a flanged connection in accordance with an embodiment of this disclosure.

FIG. 6 is a cross section view of a flanged connection in accordance with an alternate embodiment of this disclosure.

FIGS. 7-11 are section views of a gasket assembly in accordance with alternate embodiments of this disclosure.

FIGS. 12-14 are section views of a seal member profile in accordance with alternate embodiments of this disclosure.

### DETAILED DESCRIPTION OF THE EXEMPLARY EMBODIMENTS

The present invention will now be described more fully hereinafter with reference to the accompanying drawings which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout, and the prime notation, if used, indicates similar elements in alternative embodiments or positions.

In the following discussion, numerous specific details are set forth to provide a thorough understanding of the present invention. However, it will be obvious to those skilled in the art that the present invention can be practiced without such specific details. Additionally, for the most part, details concerning well drilling, reservoir testing, well completion and the like have been omitted inasmuch as such details are not considered necessary to obtain a complete understanding of the present invention, and are considered to be within the skills of persons skilled in the relevant art.

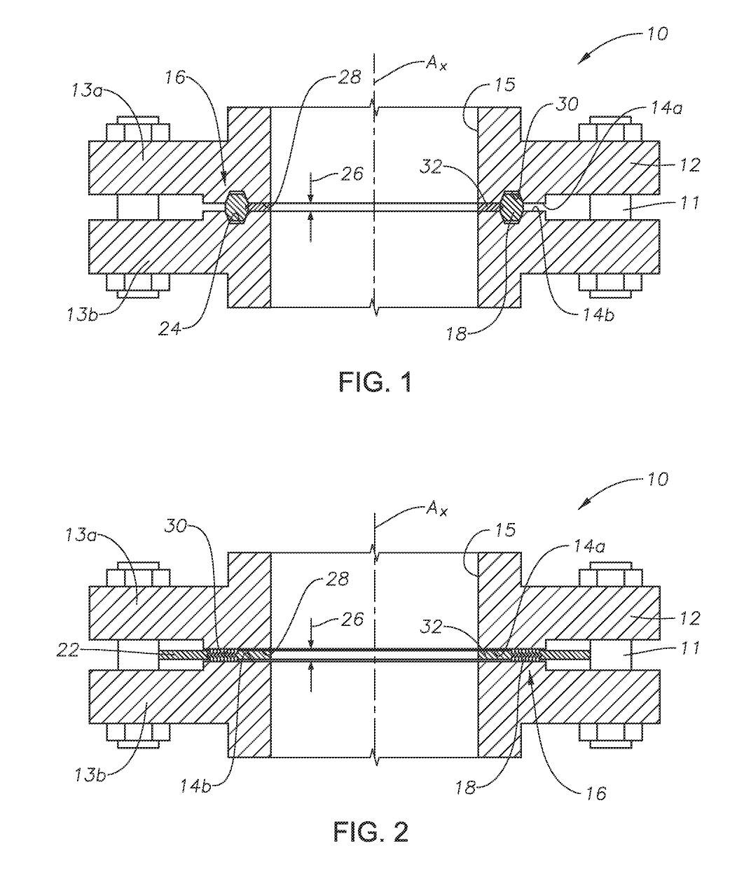

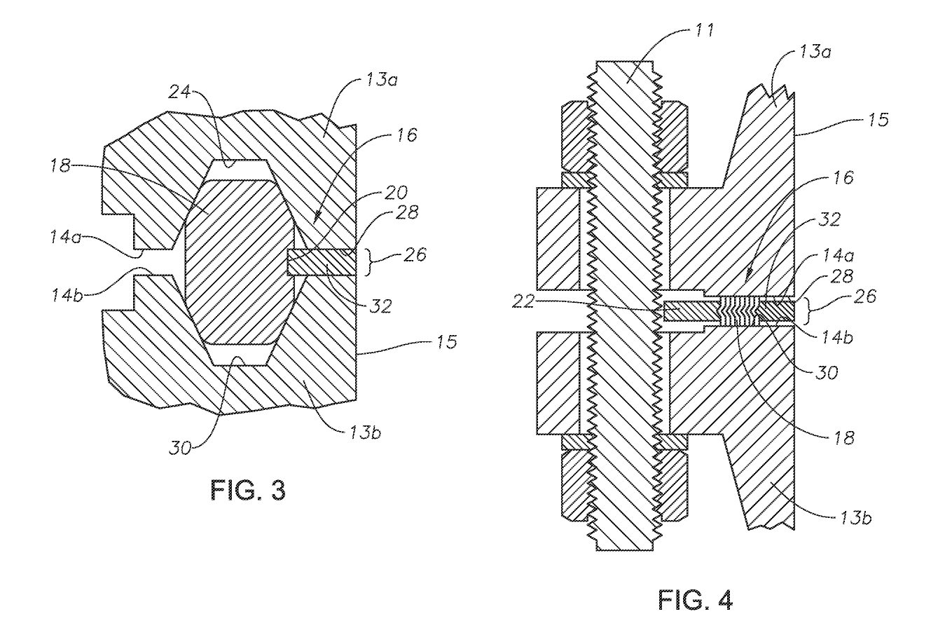

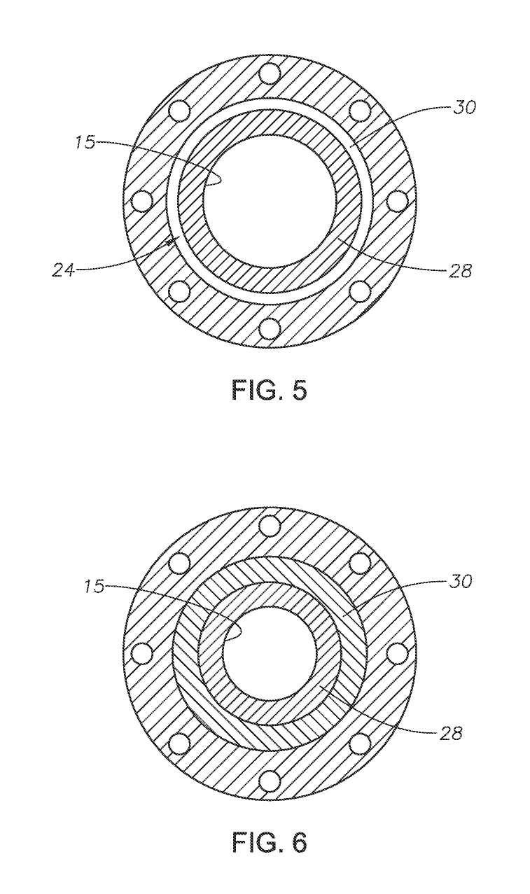

Referring to FIGS. 1-2, flanged connection 10 can connect pipes, hoses, and equipment having flanges 12. Flanged connection 10 includes first flanged member 13a and second flanged member 13b, both centered around central axis Ax. First flanged member 13a has a mating flange face 14a and second flanged member 13b has a mating flange face 14b. Mating flange faces 14a, 14b are annular shaped and when assembled, mating flange faces 14a, 14b will be directed towards each other and spaced axially apart. Flanged connection 10 can be in the form of ring joint flange (FIGS. 1, 3 and 5), raised flange (FIGS. 2, 4 and 6), or other style of flanged connection that results in mating flange faces 14a, 14b being axially spaced apart when flanges 12 are secured together. Flanges 12 can be secured together with connection members 11, which can be, for example, bolts or other threaded members, an annular clamping ring, or other known connection means.

First and second flange members 13a, 13b have a central bore 15 that circumscribes axis Ax. Flanged connection 10 can be a part of a system used for hydrocarbon recovery and processing, or in other industries where corrosive fluids will be travelling through central bore of the flanged connection 10. Embodiments of this disclosure are particularly suited for applications where the fluid flowing through central bore 15 of flanged connection 10 is under pressure.

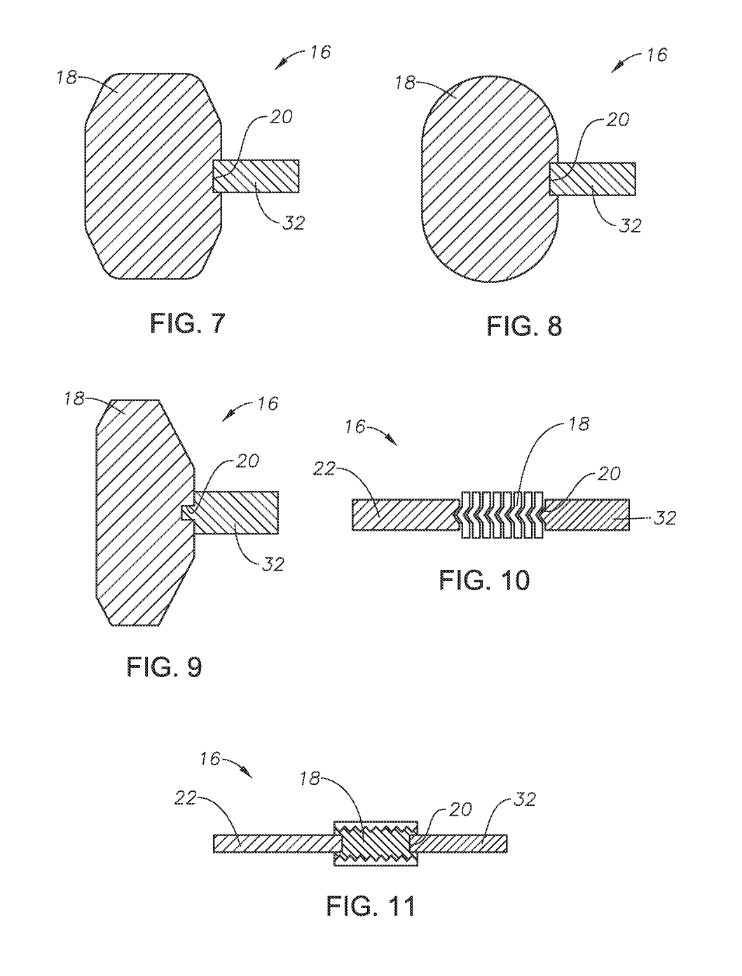

Looking at FIGS. 1-14, gasket assembly 16 seals between mating flange faces 14a, 14b of flanged connection 10. Gasket assembly 16 includes seal member 18. Seal member 18 is ring shaped and can be, for example, a metallic gasket, a camprofile gasket, a kammprofile gasket, a grooved gasket, a spiral wound gasket, or other known style of gasket known to be used with flanged connection 10. Seal member 18 can be generally sized and shaped as a current standard gasket, such as, for example, ASME B16.20 gaskets, and can be dimensionally suitable for use with flanges described in flange standards ASME B16.5, ASME B16.47 and other international standards such as, for example, BS 1560, API 6A, as well as others.

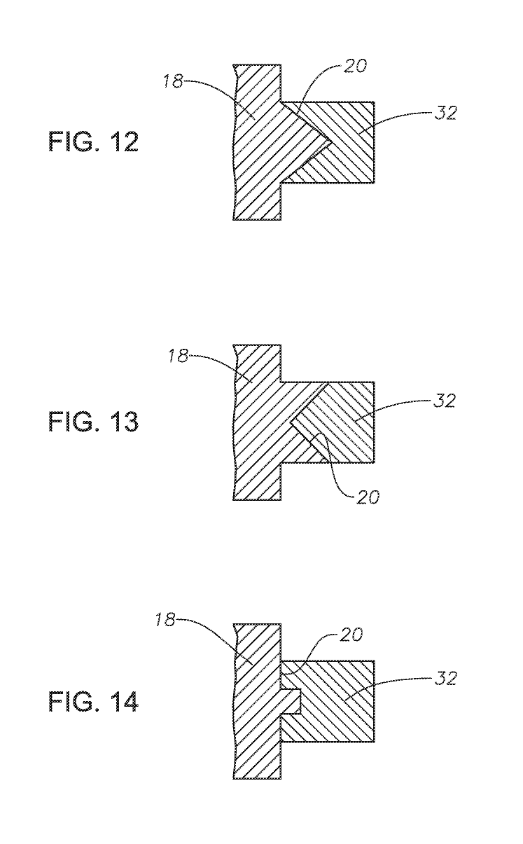

Seal member 18 has seal member profile 20 in an inner diameter of seal member 18. In the example embodiments of FIGS. 12-14, seal member profile 20 extends radially outward from the inner diameter of seal member 18. In the example embodiments of FIGS. 1-4 and 7-11, seal member profile 20 extends radially into the inner diameter of seal member 18. Seal member profile 20 can be formed by machining seal member profile 20 into seal member 18. In the example embodiments of FIGS. 12-14, seal member profile 20 would be formed by machining material off of seal member 18 around seal member profile 20 so that seal member profile 20 extends radially outward from the remaining material of seal member 18. In the example embodiments of FIGS. 1, 3, 7-9 and 11, material would instead be removed from the location of seal member profile 20 so that seal member profile 20 extends radially into the inner diameter of seal member 18.

In the example of FIGS. 2, 4 and 10, seal member 18 is a spiral wound gasket that can include a metal strip and filler material. The metal strip can be welded to galvanic anode 32 one or two times, then the metal strip and filler material is wound around galvanic anode 32. In the example of FIG. 11, seal member 18 is a grooved metal or camprofile gasket that can optionally have additional outer layers. In each of the examples of FIGS. 2, 4 and 10-11, seal member 18 can be used in a flanged connection 10 that is in the form of a raised flange, wherein the facing surfaces of mating flange faces 14a, 14b in the vicinity of seal member 18, are closer to each other than the facing surfaces proximate to connection members 11.

As shown in the examples of FIGS. 2, 4 and 10-11, seal gasket assembly 16 can include outer ring 22. Outer ring 22 can help radially center gasket assembly 16 between mating flange faces 14a, 14b of flanged connection 10. Outer ring 22 can also add radial strength to prevent a blowout of gasket assembly 16 and may also act as a compression stop. Outer ring 22 has an inner diameter that engages an outer diameter of seal member 18. Outer ring 22 extends radially outward from seal member 18, between mating flange faces 14a, 14b. In alternate embodiments, there is no outer ring 22.

In the example of FIGS. 1, 3, and 7-9, seal member 18 is an “R” style or “RX” style gasket. Such seal members 18 can be located within and engage joint groove 24 when mating flange faces 14 are secured together. Joint groove 24 is a shaped recess that extends symmetrically around axis Ax on mating flange faces 14a, 14b. Each of the mating flange faces 14a, 14b defines a portion of the joint groove 24. Seal member 18 engages and is compressed by the inner surfaces of joint groove 24 to form a seal between mating flange faces 14a, 14b.

Looking now at FIGS. 1-6, when flanges 12 of first flanged member 13a and second flanged member 13ba secured together and fluids are flowing through central bore 15, such fluids can pass into gap 26 between mating flange faces 14a, 14b and contact an annular portion 28 of mating flange faces 14a, 14b that extends from central bore 15 to seal member 18. Seal member 18 will prevent the fluids from contacting sealing surfaces 30 where seal member 18 is in contact with mating flange faces 14a, 14b. Therefore it is annular portion 28, which lies radially inward from sealing surfaces 30, that is in need of cathodic protection from corrosive fluids.

Turning again to FIGS. 1-14, gasket assembly 16 can include galvanic anode 32. Galvanic anode 32 is ring shaped and has anode profile 32 at an outer diameter, which engages seal member profile 20. Anode profile 32 is sized so that there is a loose fit between anode profile 32 and seal member profile 20. Galvanic anode 32 may be able to slide to rotate relative to seal member 18. Anode profile 32 will mate with, and correspond to, seal member profile 20 and can be generally triangular, rectangular, square, or another suitable geometric shape that will allow galvanic anode 32 to remain loosely engaged with seal member 18. In alternate embodiments, anode profile 32 can be shaped to allow galvanic anode 32 to fit tightly with seal member 18 or otherwise be fixed to seal member 18. When seal member profile 20 extends radially outward, anode profile 32 can be inserted into seal member profile 20 (FIG. 13), or seal member profile 20 can be inserted into anode profile 32 (FIGS. 12 and 14). When seal member profile 20 extends radially inward, anode profile 32 can be inserted into seal member profile 20 (FIGS. 1-4 and 7-11).

Galvanic anode 32 can be formed of material that is traditionally used for sacrificial anodes, such as, for example, aluminum, magnesium or zinc, or a combination thereof. In general, any metal can be used to protect another given there is sufficient difference in electrical potential, so galvanic anode 32 can be formed of other suitable metals. Galvanic anode 32 will protect annular portion 28 of mating flange faces 14a, 14b by providing cathodic protection; galvanic anode 32 will corrode and deteriorate, sacrificing itself to protect annular portion 28 of mating flange faces 14a, 14b.

Galvanic anode 32 extends from seal member 18 towards central bore 15. In a preferred embodiment, galvanic anode 32 extends to central bore 15 and has an inner diameter substantially similar to the diameter of central bore 15. Galvanic anode 32 should not extend into central bore 15 to interfere with the flow of fluids through central bore 15, however, the greater the radial length of galvanic anode 32, the longer galvanic anode 32 will be able to provide corrosion protection to annular portion 28, and the more cost savings will be realized.

The axial height of galvanic anode 32 shall be such that galvanic anode 32 does not interfere with the ability of seal member 18 to form and maintain an effective seal between mating flange faces 14a, 14b. In the example embodiments where seal member 18 is a metallic gasket, such as grooved metal, camprofile and kammprofile gaskets (both with and without covering layers), or where seal member 18 is a spiral wound gasket, the axial height of galvanic anode 32 shall not exceed the axial height of seal member 18. This will allow mating flange faces 14a, 14b to engage seal member 18 and form an effective seal before mating flange faces 14a, 14b engage galvanic anode 32. If seal member 18 is an “R” or “RX” type gasket, the axial height of galvanic anode 32 will be less than the axial height of seal member 18, but can be as close to the axial height of seal member 18, after flanges 12 are secured together, as possible without affecting the integrity of the seal member 18. As an example, regardless of the style or type of seal member 18, the axial height of galvanic anode 32 can be a few millimeters less than the approximate expected axial distance between mating flange faces 14a, 14b after flanges 12 are secured together. In such a way, in an example embodiment, opposite facing faces of galvanic anode 32 can be spaced apart from mating flange faces 14a, 14b after flanges 12 are secured together.

In certain embodiments, the axial height of galvanic anode 32 is directly proportional to the axial distance between mating flange faces 14a, 14b after flanges 12 are secured together. For ASME B 16.5 flanges, for example, the axial distance between mating flange faces 14a, 14b increases as the size and class of the flanged connection 10 increases. At the same time, however, the diameter of central bore 15 does not increase. Therefore, the volume of material of galvanic anode 32 will increase as the size and class of the flanged connection 10 increases, to provide more corrosion protection and a resulting longer life for larger sizes and classes of flanged connections 10.

In an example of operation, to seal between mating flange faces 14a, 14b of flanged connection 10, gasket assembly 16 is inserted between mating flange faces 14a, 14b before mating flange faces 14a, 14b are secured together. In the example embodiments with mating flange faces 14a, 14b having joint groove 24, seal member 18 can be inserted within and engage joint groove 24 when mating flange faces 14 are secured together. In example embodiments including outer ring 22, outer ring 22 can assist in radially centering gasket assembly 16 about axis Ax between mating flange faces 14a, 14b. Galvanic anode 32 can be sized and inserted between mating flange faces 14a, 14b so that galvanic anode 32 extends from seal member 18 to central bore 15, providing long lasting corrosion protection by way of cathodic protection to annular portion 28.

Mating flange faces 14a, 14b, can then be secured to each other by way of securing flanges 12 together with connection members 11, compressing seal member 18 between mating flange faces 14a, 14b, while maintaining an axial space between each of opposite facing faces of galvanic anode 32 and mating flange faces 14a, 14b.

Embodiments of the systems and methods described in this disclosure are therefore expected to produce cost savings by avoiding the necessity to replace or repair flanged connector 10 due to corrosion. In addition, embodiments of this disclosure can help to avoid unscheduled plant operations shutdowns that may occur because of flanged connection 10 leaks. This results in the safety benefit of reducing potential releases of a toxic substance, such as H2S, into the environment. Because embodiments of this disclosure are interchangeable with standard gaskets without making other modifications to flanged connection 10, gasket assembly 16 of this disclosure would be relatively simply implemented into operations.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

What is claimed is:

1. A gasket assembly for sealing between mating flange faces of a flanged connection with a central bore, the gasket assembly comprising:
a seal member, the seal member being ring shaped and having a seal member profile on an inner diameter; and
a galvanic anode, the galvanic anode being ring shaped member with an outer diameter in engagement with the seal member profile and an inner diameter at least as large as a diameter of the central bore.

2. The gasket assembly according to claim 1, wherein the galvanic anode is formed of a material selected from a group consisting of aluminum, magnesium and zinc.

3. The gasket assembly according to claim 1, wherein the galvanic anode has an axial height less than a distance between the mating flange faces.

4. The gasket assembly according to claim 1, wherein the seal member is sized to selectively engage a ring joint groove of the mating flange faces and the galvanic anode is sized to extend from the ring joint groove to the central bore.

5. The gasket assembly according to claim 1, further including an outer ring, the outer ring having an inner diameter that engages an outer diameter of the seal member.

6. The gasket assembly according to claim 1, wherein the seal member profile extends radially outward from the inner diameter of the seal member and the outer diameter of the galvanic anode has an anode profile that engages the seal member profile.

7. The gasket assembly according to claim 1, wherein the seal member profile extends radially into the inner diameter of the seal member and the outer diameter of the galvanic anode has an anode profile that engages the seal member profile.

8. A sealed flanged connection comprising:
mating flange faces with a central bore, the mating flange faces being annular members spaced axially apart;
a seal member located between the mating flange faces and forming a seal between the mating flange faces, the seal member being ring shaped and having a seal member profile on an inner diameter; and
a galvanic anode, the galvanic anode being ring shaped member with an outer diameter in engagement with the seal member profile and extending from the seal member towards the central bore, and wherein opposite facing faces of the galvanic anode are spaced apart from the mating flange faces.

9. The sealed flanged connection according to claim 8, further comprising a joint groove located on each of the mating flange faces, wherein the seal member is located within the joint groove and the galvanic anode extends from the joint groove to the central bore.

10. The sealed flanged connection according to claim 8, further including an outer ring, the outer ring having an inner diameter that engages an outer diameter of the seal member and extending radially outward from the seal member between the mating flange faces.

11. The sealed flanged connection according to claim 8, wherein the outer diameter of the galvanic anode loosely engages the seal member profile.

12. The sealed flanged connection according to claim 8, wherein the outer diameter of the galvanic anode is fixed to the seal member.

13. The sealed flanged connection according to claim 8, wherein the galvanic anode is formed of a material selected from a group consisting of aluminum, magnesium and zinc.

14. The sealed flanged connection according to claim 8, wherein the seal member is selected from a group consisting of metallic gasket, camprofile gasket, kamprofile gasket, grooved gasket, and spiral wound gasket.

15. A method of sealing between a pair of flanges of a flanged connection with a central bore, the method comprising:
inserting a gasket assembly between mating flange faces of the flanged connection, the gasket assembly having a seal member with ring shape and an inner diameter, and a galvanic anode with a ring shape and an outer diameter in engagement with the seal member profile; and
securing the flanges to each other to compress the seal member between the mating flange faces, while maintaining a space between each of opposite facing faces of the galvanic anode and the mating flange faces.

16. The method according to claim 15, further comprising sizing the galvanic anode to extend from the seal member to the central bore to protect an annular portion of the mating flange faces between the seal member and the central bore from corrosion with the galvanic anode.

17. The method according to claim 15, wherein the mating flange faces each have a joint groove, and wherein the step of inserting the gasket assembly between the mating flange faces includes inserting the seal member within the joint groove.

18. The method according to claim 17, wherein the gasket assembly includes an outer ring with an inner diameter that engages an outer diameter of the seal member, and wherein the step of inserting the gasket assembly between the mating flange faces includes radially centering the gasket assembly between the mating flange faces with the outer ring.
